(19) United States
(12) Patent Application Publication
(10) Pub. No.: US 2025/0390497 A1
(43) Pub. Date: Dec. 25, 2025

(54) DATA INTEGRATION PLUG-IN FOR DATA ANALYSIS PLATFORM

(71) Applicant: Schlumberger Technology Corporation, Sugar Land, TX (US)

(72) Inventors: Ramchandra Nile, Pune (IN); Neerajkumar Dilip Bhatewara, Pune (IN); Snehal Jagtap, Pune (IN); Gargi Bhosale, Pune (IN)

(21) Appl. No.: 19/243,958

(22) Filed: Jun. 20, 2025

(30) Foreign Application Priority Data
Jun. 20, 2024 (IN) 202411047564

(51) Int. Cl. G06F 16/2455; G06F 16/242; G06F 16/25

(52) U.S. Cl. CPC G06F 16/24556; G06F 16/244; G06F 16/252

(57) ABSTRACT

A computing system includes a data aggregation platform configured to store one or more databases. The computing system further includes a data analysis platform having a data flow user interface (UI) configured to provide an environment for a user to configure a data flow. Additionally, the data analysis platform includes a data integration plug-in comprising a function that, when executed, is configured to cause the data integration plug-in to receive a user inputs indicative of query parameters. Additionally, the function, when executed, is configured to cause the data integration plug-in to transform the user inputs into a query interpretable by the data aggregation platform. Furthermore, the function, when executed, is configured to execute the query to retrieve an input dataset from the data aggregation platform.

### CROSS-REFERENCE TO RELATED APPLICATION

This application claims priority to and the benefit of Indian Application No. 202411047564, entitled “DATA INTEGRATION PLUG-IN FOR DATA ANALYSIS PLATFORM,” filed Jun. 20, 2024, which is hereby incorporated by reference in its entirety for all purposes.

### BACKGROUND

The present disclosure generally relates to systems and methods for providing a data integration plug-in for transferring data between a data analysis platform and a data aggregation platform.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Petrotechnical data is collected from various domains of upstream business, spanning drilling simulation, seismic, well placement, reservoir characterization, reservoir simulation, fracture modeling, geological modeling, gridding and upscaling, well and completion design to production design and optimization, and so on. Automated data flows may be used to ingest, process, publish, and draw insights from this data.

### SUMMARY

A summary of certain embodiments described herein is set forth below. It should be understood that these aspects are presented merely to provide the reader with a brief summary of these certain embodiments and that these aspects are not intended to limit the scope of this disclosure.

In certain embodiments a method includes providing, by a data integration plug-in for a data analysis platform, a user interface comprising user input fields. Additionally, the method includes receiving, via the data integration plug-in, respective user inputs corresponding to the user input fields. Furthermore, the method includes generating, via the data integration plug-in, a query in a database query language based on the user inputs. Moreover, the method includes receiving, via the data integration plug-in, input data from a data aggregation platform in response to the query. The method further includes importing, via the data integration plug-in, the input data to the data analysis platform.

In certain embodiments, a computing system includes a data aggregation platform configured to store one or more databases. The computing system further includes a data analysis platform having a data flow user interface (UI) configured to provide an environment for a user to configure a data flow. Additionally, the data analysis platform includes a data integration plug-in comprising a function that, when executed, is configured to cause the data integration plug-in to receive a user inputs indicative of query parameters. Additionally, the function, when executed, is configured to cause the data integration plug-in to transform the user inputs into a query interpretable by the data aggregation platform. Furthermore, the function, when executed, is configured to execute the query to retrieve an input dataset from the data aggregation platform.

In certain embodiments, a method includes providing, via a data analysis platform, a data flow user interface (UI) for configuring a data flow in a computing system. The method further includes ingesting, by the data analysis platform, input data from a data aggregation platform via a data integration plug-in of the data analysis platform. Additionally, the method includes integrating, via the data analysis platform, the input data into the data flow. Furthermore, the method includes generating, via the data analysis platform, output data based on the input data via the data flow. Additionally, the method includes writing, via the data analysis platform, the output data to the data aggregation platform using an instruction generated by the data integration plug-in.

### BRIEF DESCRIPTION OF THE DRAWINGS

Various aspects of this disclosure may be better understood upon reading the following detailed description and upon reference to the drawings, in which:

FIG. 1 is a schematic of a computing system for processing data, in accordance with an aspect of the present disclosure;

FIG. 2 is a block diagram of a data integration plug-in, in accordance with an aspect of the present disclosure;

FIG. 3 is an illustration of an example user interface of a data integration plug-in, in accordance with an aspect of the present disclosure;

FIG. 4 is an illustration of an example user interface of a data integration plug-in, in accordance with an aspect of the present disclosure;

FIG. 5 is an illustration of an example user interface of a data analysis platform, in accordance with an aspect of the present disclosure;

FIG. 6 is a flowchart of a method for ingesting and writing data using a data integration plug-in, in accordance with an aspect of the present disclosure; and

FIG. 7 is a flowchart of a method for implementing a data flow, in accordance with an aspect of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed or caused to be performed, for example, by a computing system (i.e., solely by the computing system, without human intervention). In addition, as used herein, the term “approximately equal to” may be used to mean values that are relatively close to each other (e.g., within 5%, within 2%, within 1%, within 0.5%, or even closer, of each other).

Oil and gas operations generate data across many domains including exploration, drilling, production, refining, and distribution. This data may be used to monitor operational processes, generate business insights, improve safety, drive operational efficiency, and enhance decision-making. Using data analytics technology (e.g., machine learning), valuable insights can be extracted from operational data automatically and at scale. These insights may encompass a wide range of domains, including reservoir characterization, well optimization, asset maintenance, supply chain management, and market intelligence, among many others.

A computing system for generating insights from data may include a data aggregation platform (e.g., Cognite Data Fusion, and so forth) configured to store and manage access to data across an enterprise. For example, the data aggregation platform may include servers (e.g., cloud servers, in certain embodiments) configured to receive and store data from sensors, applications, and other myriad data sources. The data stored in the data aggregation platform may be accessed using a query language, such as GraphQL or SQL. In certain embodiments, the data aggregation platform may implement a data framework (e.g., Flexible Data Model as but one non-limiting example) for managing and manipulating diverse data types and structures. As such, queries and manipulations of data on the data aggregation platform may be performed in accordance with the data framework. Such operations may require a level of technical expertise (e.g., programming knowledge) barring would-be users from easily interfacing with the data aggregation platform.

The computing system may further include a data analysis platform (e.g., Dataiku as but one non-limiting example) that analyzes the data to produce useful insights. For example, the data analysis platform may include tools to clean the data, generate statistics, train and run machine learning models, and/or visualize the data. Additionally, the data analysis platform may include a digital environment with a user interface for creating data flows. As referred to herein, a “data flow” is a sequence of operations that are performed to record, ingest, process, manipulate, draw insights from, and/or act upon one or more sets of data. In some cases, a data flow may be at least partially automated such that outputs (e.g., insights, visualizations, actions, and so forth) may be produced automatically as data flows into the data analysis platform.

The present disclosure relates to a data integration plug-in for a data analysis platform that facilitates user-friendly transfer (e.g., data ingestion, processing, and writing) of data between the data analysis platform and a data aggregation platform. The data integration plug-in may be integrated within the data analysis platform to add data ingestion, processing, and writing functionality to the data analysis platform. Specifically, the data integration plug-in may receive user inputs indicative of a desired action to be performed (i.e., a data action). Then, the data integration plug-in may generate a script, a query, and/or a command to interface with the data aggregation platform in a suitable format (e.g., a query language). The data action may be incorporated into a data flow running on the data analysis platform. That is, the data integration plug-in may perform the data action as part of the data flow within the data analysis platform. The data action may include ingesting raw input data from the data aggregation platform into the data flow, pre-processing (e.g., filtering, pivoting, selecting) the input data, and writing output data to the data aggregation platform. By making it easier for a user to interact with the data aggregation platform via the data analysis platform, barriers to the development of data flows may be lowered, enabling greater accessibility to data-based outcomes to a wider range of users (e.g., domain experts, managers, business-facing users, and so forth).

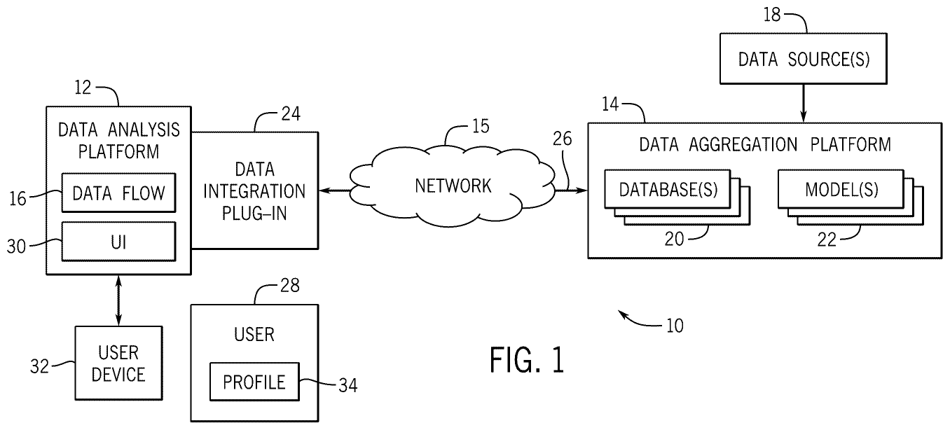

With the foregoing in mind, FIG. 1 illustrates a computing system 10 that includes a data analysis platform 12 and a data aggregation platform 14. In certain embodiments, the data analysis platform 12 is a software application that provides a development environment for creating, running, and managing one or more data flows 16. In certain embodiments, the data analysis platform 12 may be hosted on a server (e.g., cloud server, in some embodiments) that communicates with other devices (e.g., servers, clients, and so forth) over a network 15. The data aggregation platform 14 may receive aggregated data from various data sources 18, such as sensors, drilling equipment, and the internet. The data received from the various data sources 18 may include time series objects containing data points in time order. Examples of a time series are the temperature of a drill bit, an oil tank level, a flow rate through a valve over time, and so forth. The data aggregation platform 14 may record the data in one or more databases 20. The databases 20 may be stored in one or more storage devices of a server (e.g., cloud server) that communicates with other devices (e.g., other servers, clients, data analysis platform 12, in some embodiments). Additionally, the data aggregation platform 14 may include data models 22 that organize data elements and standardize how they relate to one another and the properties of real-world entities (e.g., subsurface formations, drilling equipment, industrial systems, and so forth).

As discussed above, a data flow 16 may be defined as a sequence of operations that ingest, manipulate, analyze, or otherwise engage with data. Some data flows 16 may include operations to ingest data from an external source (e.g., the data aggregation platform 14) and produce output data of various kinds, such as visualizations, actions, processed datasets, and so forth. For example, a data flow 16 may include an operation to interface with the data aggregation platform 14, such as ingesting a portion of a dataset from a certain database 20 or model 22 stored on the data aggregation platform 14.

Presently recognized is a need to efficiently provide data from the data aggregation platform 14 to the data analysis platform 12 to be used in the data flows 16. Thus, the computing system 10 includes a data integration plug-in 24 configured to establish a data pipeline 26 between the data analysis platform 12 and the data aggregation platform 14. The data integration plug-in 24 may be a software component that adds functionality onto a pre-existing data analysis platform 12, such as Dataiku. For example, the data integration plug-in 24 may include a function to import a pre-processed dataset from the data aggregation platform 14 into a data flow 16 so that the data analysis platform 12 can analyze the pre-processed dataset. Further, the data integration plug-in 24 may include a function to export (e.g., write) an output dataset generated by the data analysis platform 12 to the data aggregation platform 14 (e.g., database(s) 20).

As such, the data integration plug-in 24 may be configured to convert data flows 16 and associated datasets, for example, from organization-specific data types and structures (e.g., of an organization with which a particular user 28 is associated) to industry-specific data types and structures (e.g., that are standardized based on industry standards in the data aggregation platform 14). Other examples of such data conversion that may be performed by the data integration plug-in 24 may be to convert role-specific data types and structures (e.g., based on specific roles of a particular user 28 with respect to their associated organization) to the industry-specific data types and structures (e.g., that are standardized based on industry standards in the data aggregation platform 14). In this manner, the data integration plug-in 24 may facilitate a particular user 28 to interact with the data aggregation platform 14 despite the fact that the particular user 28 may not be particularly familiar with the particular data types and structures stored by the data aggregation platform 14, for example, if the particular user 28 lacks particular type of knowledge, such as engineering-specific data types and structures if the particular user 28 is a management level person.

A user 28 may engage with the data analysis platform 12 via a user interface (UI) 30. In certain embodiments, the data analysis platform 12 may be hosted on a server, and the user 28 may access the data analysis platform 12 from a user device 32 (e.g., PC, laptop, mobile device) via which the UI 30 may be displayed to the user 28. The UI 30 of the data analysis platform 12 may include workspaces, menus, and tools to facilitate creation of a data flow 16. For example, the user 28 may drag-and-drop graphical elements (e.g., icons, arrows, and so forth) into a workspace to create a diagram (e.g., directed acyclic graph, data flow diagram, and so forth) representing the data flow 16. The data analysis platform 12 may interpret the arrangement of the graphical elements into computing operations (e.g., a script) and then execute a computational workflow corresponding to the data flow 16. In certain embodiments, the user 28 may be associated with a profile 34 containing data regarding the user's identity, roles, and permissions. For example, the profile 34 may indicate that the user 28 is permitted to view, modify, and/or execute a particular data flow 16.

One embodiment of the present disclosure is where the data analysis platform 12 may not, on its own, provide a UI 30 for interfacing with the data aggregation platform 14. Therefore, the data integration plug-in 24 may be provided as an add-on to the data analysis platform 12. In particular, the data integration plug-in 24 may provide its own UI specifically to receive user inputs related to operations involving the data aggregation platform 14. The user inputs may be indicative of query parameters defining a query to be executed on the data aggregation platform 14.

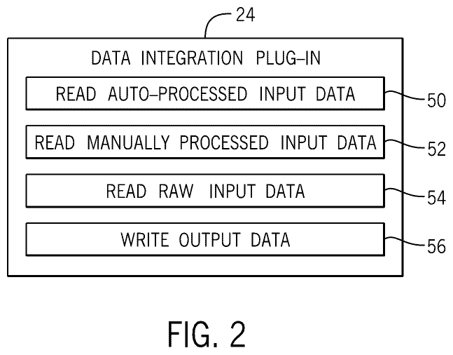

FIG. 2 illustrates some example components of the data integration plug-in 24. For example, the data integration plug-in 24 may include a first component 50 (e.g., function, operation, command, module, script, program, instruction) configured to read input data from the data aggregation platform 14, wherein the input data is automatically pre-processed (e.g., filtered) to provide an input dataset having certain properties, such as a particular format, scope, selection, and/or type. For example, the data integration plug-in 24 may provide user input fields and selectable options to the user 28 to collect user inputs indicative of parameters to be used for pre-processing the input data. Then, the data integration plug-in 24 may generate and execute instructions (e.g., queries) in a query language (e.g., GraphQL) understood by the data aggregation platform 14. In this way, the user 28 may import the input data from the data aggregation platform 14 into the data flow 16 in a readily usable form without writing much, or any, code. Thus, the data integration plug-in 24 may abstract the technology underlying the transfer of information between the data analysis platform 12 and the data aggregation platform 14.

The data integration plug-in 24 may further include a second component 52 configured to read input data from the data aggregation platform 14, wherein the input data is manually pre-processed to provide an input dataset having certain properties, such as a particular format, scope, selection, and/or type. For example, the data integration plug-in 24 may receive instructions (e.g., queries) from the user 28 directly in the query language, without the abstraction provided by the first component 50. In this way, the user 28 may interact with the data aggregation platform 14 in a more customized way, which may be suitable for more advanced users and/or sophisticated use cases.

The data integration plug-in 24 may further include a third component 54 configured to read input data from the data aggregation platform 14, wherein the input data is raw data read directly from the databases 20 and/or the models 22. That is, the raw data may not be pre-processed or manipulated prior to ingestion to the data analysis platform 12. In such cases, further manipulation of the raw data may be performed in the data analysis platform 12 to make the raw data usable.

The data integration plug-in 24 may further include a fourth component 56 configured to write output data from the data analysis platform 12 to the data aggregation platform 14. For example, in certain embodiments, the data flow 16 may train a machine learning model on a training dataset received from the data aggregation platform 14 or another data source 18. Then, the data flow 16 may receive additional dataset(s) and predict an output dataset using the additional dataset(s) as an input to the machine learning model. Then, the data flow 16 may write the output dataset to the data aggregation platform 14 to be viewed, shared, and/or used in other data flows.

As such, the data integration plug-in 24 may provide various components 50, 52, 54, 56 that provide varying functionalities to users 28, for example, based on the specific characteristics of the users 28 (e.g., identities, roles, and permissions) such that, for example, users 28 of varying technical ability can interact with data aggregation platforms 14 in a same or similar manner. Furthermore, as described in greater detail herein, the data integration plug-in 24 may provide plug-in UIs (e.g., that may generally correlate to functionality provided by the various components 50, 52, 54, 56 of the data integration plug-in 24) that might not otherwise be available to users 28, thereby extending the functionalities of certain data aggregation platforms 14.

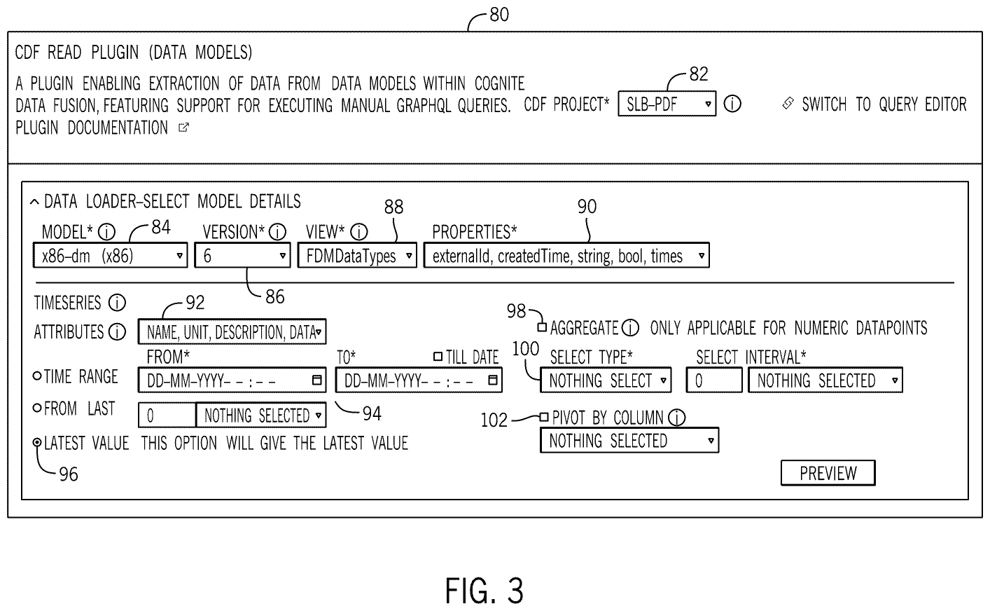

FIG. 3 illustrates an example plug-in UI 80 corresponding to the first component 50 of the data integration plug-in 24. That is, the plug-in UI 80 is configured to present user input fields for parameters associated with reading automatically pre-processed data from the data aggregation platform 14. In certain embodiments, the plug-in UI 80 may be presented on a display of a user device 32 in response to selection of the first component 50 of the data integration plug-in 24 by the user 28. It will be appreciated that other example plug-in UIs 80 may be provided in response to selection of other components 52, 54, 56 of the data integration plug-in 24 by the user 28.

The plug-in UI 80 illustrated in FIG. 3 includes a project field 82 in which the user 28 may enter or select a project of the data aggregation platform 14 to which a query will be directed. Further, the user 28 may enter or select a particular model from a model field 84, a version of the model from a version field 86, and a view (e.g., table) of the particular model from a view field 88. User inputs to these user input fields identify a location of exploration in the data aggregation platform 14 for some target data. Additionally, the user 28 may select certain properties (e.g., data features, columns, and so forth) to investigate from the identified data location.

Once the properties are selected via the plug-in UI 80, the user 28 may further specify the query by selecting attributes of a time series from an attribute field 92, such as a target value and a timestamp. Additionally, the user 28 may select a time range to explore from a time range field 94. Alternatively, the user 28 may select a latest value option 96 to retrieve the latest value from a time series. Furthermore, the user 28 may select an aggregate option 98 to find an aggregate value of the time series within the time range. In addition, other statistics options 100 may be selected to find statistics, such as a count, an average, a sum, a maximum value, or a minimum value of the time series. Further, the user 28 may select a pivot option 102 to pivot the target data by a selected column.

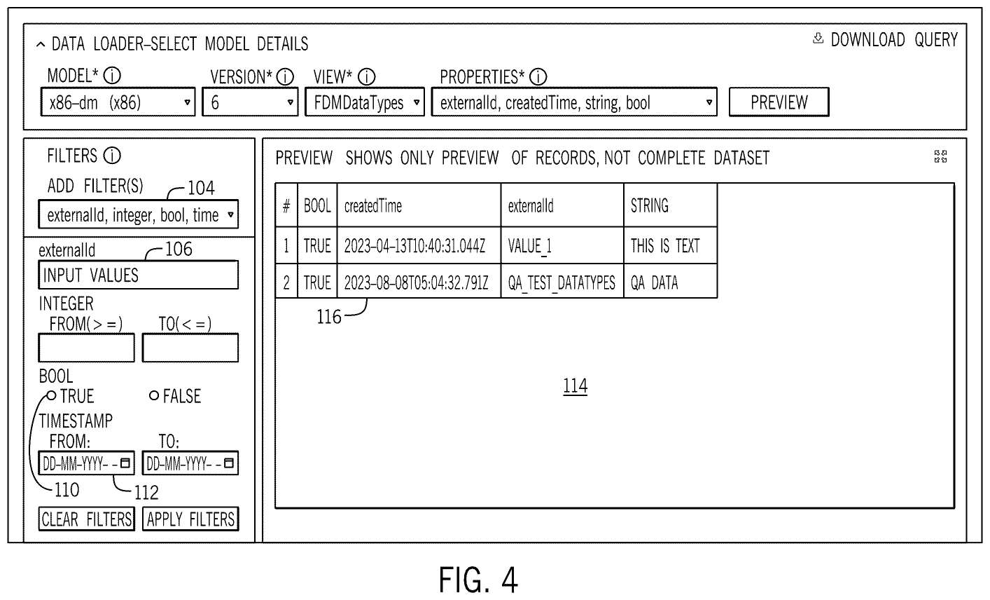

FIG. 4 illustrates further elements of the plug-in UI 80 containing filters for the target data. For example, the user 28 may filter the target data based on a data type 104, a string type of property 106, an integer range 108, a Boolean value 110, and a time range for date/time fields 112 (e.g., created date of asset). The user inputs into these user input fields specify (e.g., characterize, indicate, and so forth) the target data to be explored and filters for relevant data within the target data. The plug-in UI 80 may include a preview window 114 to show a preview of an input dataset 116 that would be retrieved by the data integration plug-in 24 using the user inputs. Based on the user inputs, the data integration plug-in 24 may generate a query or other instruction in the query language to capture the information provided by the user 28 in the user input fields. Then, the query may be executed as part of the data flow 16 to import the input dataset 116 to the data analysis platform 12.

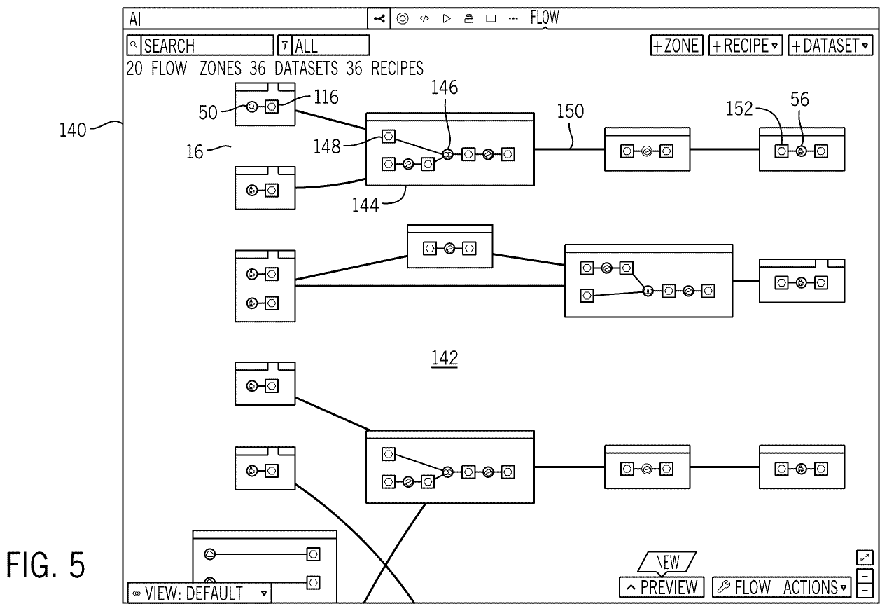

FIG. 5 illustrates a data flow UI 140 of the data analysis platform 12. The data flow UI 140 may include various graphical elements arranged in a workspace 142. For example, the graphical elements may include tasks 144 containing operations 146 to be performed on datasets 148. The tasks 144 may be connected to one another via arrows 150 indicating the flow of data. The tasks, operations 146, and arrows 150 may be dragged and dropped onto the workspace 142 by the user 28. In this way, the user 28 may develop and/or view the data flow 16 in an intuitive way. The graphical elements may also include an icon representing the first component 50 of the data integration plug-in 24 as an operation 146 to ingest the input dataset 116. Additionally, the data flow 16 may include the fourth component 56 of the data integration plug-in 24 to write an output dataset 152 to the data aggregation platform 14. As such, as discussed above, the data integration plug-in 24 may enable the data flow UI 140 of the data analysis platform 12 to facilitate the functionality provided by the various components 50, 52, 54, 56 of the data integration plug-in 24 to be presented to users 28 of the data analysis platform 12 where the functionality might otherwise not be available.

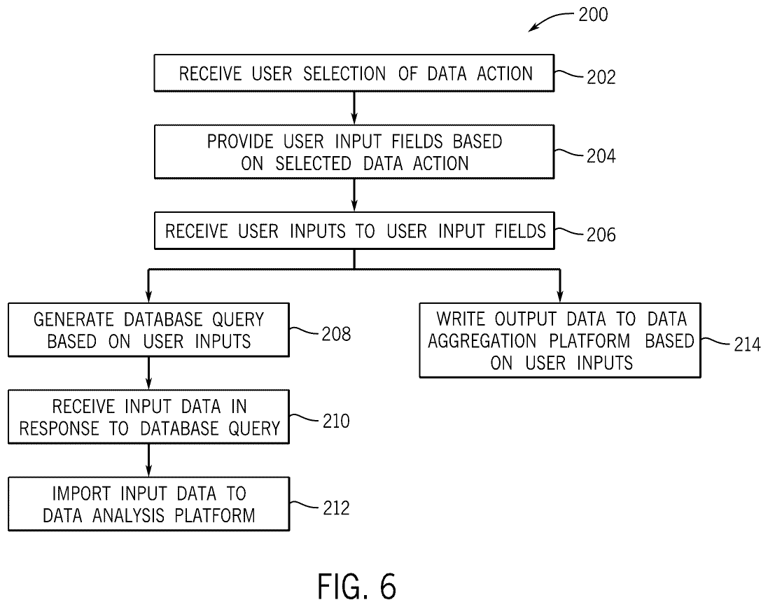

FIG. 6 illustrates a method 200 of operation of the data integration plug-in 24 for interfacing with a data aggregation platform 14. Although the following description of the method 200 is described in a particular order, it should be noted that the method 200 may be performed in any suitable order.

At block 202, the data integration plug-in 24 may receive a user selection of a data action to be performed (e.g., via a data flow UI 140 of the data analysis platform 12). The selected data action may correspond to a first component 50, a second component 52, a third component 54, or a fourth component 56 of the data integration plug-in 24. For example, the selected data action may be a request to read automatically pre-processed input data from the data aggregation platform 14 (e.g., using the first component 50 of the data integration plug-in 24).

At block 204, the data integration plug-in 24 may populate a plug-in UI 80 with user input fields based on the selected data action. That is, the selected data action may determine what user input fields are shown. For example, if the selected data action is to read automatically pre-processed input data from the data aggregation platform 14, then the user input fields may include the project field 82, the model field 84, the version field 86, the view field 88, and/or the properties field 90, as described above with respect to FIG. 3. Additionally, the user input fields may include fields to select filters, such as the data type 104, the string type of property 106, the integer range 108, the Boolean value 110, and the time range for date/time fields 112, as described above with respect to FIG. 4. These filters may include or exclude certain categories of data from the query.

At block 206, the data integration plug-in 24 may receive user inputs to the user input fields described with reference to block 204. For example, at each user input field, the data integration plug-in 24 may receive a string input, numerical input, a selection from a list, or a toggle (e.g., Boolean) input. These user inputs specify a target data for exploration.

Performance of subsequent steps of the method 200 may depend on the data action selected at block 202. For example, if the selected data action is to read automatically pre-processed input data from the data aggregation platform 14, then the method 200 may proceed to block 208. At block 208, the data integration plug-in 24 may generate a query or instruction based on the user inputs received at block 206. The query or instruction may be generated in the form of a query language interpretable by the data aggregation platform 14 or the databases 20 and models 22 therein. For example, the data integration plug-in 24 may incorporate the user inputs into a pre-determined query template corresponding to the selected data action. The data integration plug-in 24 may execute the query to retrieve input data from the data aggregation platform 14. At block 210, the data integration plug-in 24 may receive the input data in response to the query. At block 212, the data integration plug-in 24 may import the input data to the data analysis platform 12. In particular, the input data may be imported to the data flow 16 where various operations may be performed to manipulate the data and derive insights.

However, if the data action selected at block 202 is to write output data to the data aggregation platform 14, then the method 200 may proceed from block 202 to block 204, where the plug-in UI 80 may again provide user input fields. In this case, however, the user input fields may differ based on the different data action. For example, the user input fields may include a write location for the output data. Then, the method 200 may proceed to block 206, where the data integration plug-in 24 receives user inputs to the user input fields. At block 214, the data integration plug-in 24 may write the output data from a data flow to the data aggregation platform 14 based on the user inputs. For example, the output data may include predictions of a machine learning model trained on input data retrieved from the data aggregation platform 14 at a preceding point of the data flow 16.

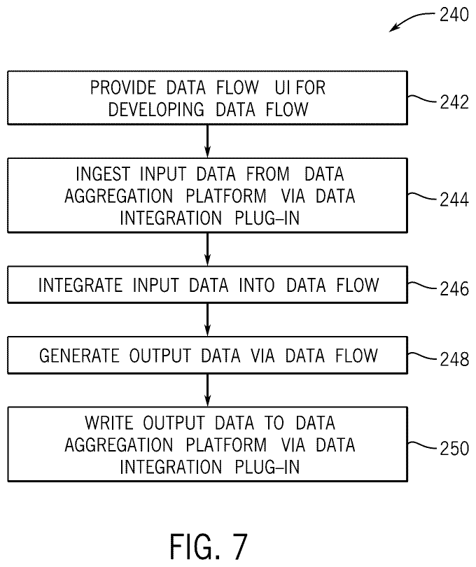

FIG. 7 illustrates a method 240 of operation of the data analysis platform 12 for interfacing with the data aggregation platform 14 using the data integration plug-in 24. Although the following description of the method 240 is described in a particular order, it should be noted that the method 240 may be performed in any suitable order.

At block 242, the data analysis platform 12 may provide a data flow UI 140 for developing a data flow 16. In certain embodiments, the data flow UI 140 may be provided by a server of the data analysis platform 12 to a client device (e.g., user device 32) for display. The client device may include input devices, such as a keyboard, a mouse, and/or a touchscreen for the user 28 to interact with the data flow UI 140.

At block 244, the data analysis platform 12 may ingest input data from the data aggregation platform 14 using the data integration plug-in 24. For example, the data analysis platform 12 may execute a data flow 16 containing a call for the data integration plug-in 24 to perform the method 200 described above. In this way, the input data may be imported to the from the data aggregation platform 14 to the data analysis platform 12.

At block 246, the data analysis platform 12 may integrate the input data into the data flow 16. That is, the input data may be selectively operated upon in a user-defined sequence as defined by the arrangement of graphical elements in the data flow UI 140. As part of the data flow 16, the input data may be cleaned, processed, analyzed, visualized, or otherwise manipulated in a desired manner. In certain embodiments, the input data may be used to train a machine learning model. Alternatively, the input data may be used as an input to an existing machine learning model to predict output data. At block 248, the data analysis platform 12 may generate the output data via the data flow 16.

At block 250, the data analysis platform 12 may write the output data to the data aggregation platform 14 using the data integration plug-in 24. For example, the data flow 16 may include a call for the data integration plug-in 24 to perform block 214 of the method 200 described with reference to FIG. 6. Writing the output data may include transforming user inputs to the plug-in UI 80 into instructions in the query language. In this way, a bi-directional data pipeline 26 may be established by the data integration plug-in 24 between the data analysis platform 12 and the data aggregation platform 14.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
providing, by a data integration plug-in for a data analysis platform, a user interface comprising a plurality of user input fields;
receiving, via the data integration plug-in, a respective plurality of user inputs corresponding to the plurality of user input fields;
generating, via the data integration plug-in, a query in a database query language based on the user inputs;
receiving, via the data integration plug-in, input data from a data aggregation platform in response to the query; and
importing, via the data integration plug-in, the input data to the data analysis platform.

2. The method of claim 1, comprising:
receiving, via the data integration plug-in, a request to write output data to the data aggregation platform;
providing, via the data integration plug-in, the user interface comprising a plurality of additional user input fields;
receiving, via the data integration plug-in, a respective plurality of additional user inputs corresponding to the additional user input fields;
generating, via the data integration plug-in, instructions in the database query language based on the additional user inputs to write the output data to the data aggregation platform.

3. The method of claim 2, wherein the additional user inputs comprise a write location for the output data in the data aggregation platform.

4. The method of claim 1, wherein the user inputs are indicative of query parameters defining the query.

5. The method of claim 4, wherein the user inputs comprise a location of target data in the data aggregation platform.

6. The method of claim 1, wherein the user inputs comprise a selection of one or more time ranges, the query is configured to request time series data points corresponding to the one or more time ranges, and the input data comprises the requested time series data points.

7. The method of claim 1, comprising providing the input data to a data flow, wherein the data flow is configured to use the input data as to input to a machine learning model.

8. A computing system, comprising:
a data aggregation platform configured to store one or more databases;
a data analysis platform, comprising:
a data flow user interface (UI) configured to provide an environment for a user to configure a data flow; and
a data integration plug-in comprising a first function that, when executed, is configured to cause the data integration plug-in to:
receive a plurality of user inputs indicative of query parameters;
transform the user inputs into a query interpretable by the data aggregation platform; and
execute the query to retrieve an input dataset from the data aggregation platform.

9. The computing system of claim 8, wherein the data flow comprises ingestion of the input dataset to a machine learning model.

10. The computing system of claim 8, wherein the data analysis platform is hosted on a server, and the computing system comprises a client device configured to access the data analysis platform over a network.

11. The computing system of claim 8, wherein the data aggregation platform is configured to receive aggregated data from data sources comprising at least one sensor.

12. The computing system of claim 8, wherein the data integration plug-in comprises a second function that, when executed, is configured to cause the data integration plug-in to:
receive the query from the user in a database query language; and
execute the query to retrieve the input dataset from the data aggregation platform, wherein the input dataset is pre-processed based on the query.

13. The computing system of claim 12, wherein the data integration plug-in comprises a third function that, when executed, is configured to:
receive the query from the user in a database query language; and
execute the query to retrieve the input dataset from the data aggregation platform, wherein the input dataset is not pre-processed based on the query.

14. The computing system of claim 13, wherein the data analysis platform is configured to analyze the input dataset via the data flow and generate an output dataset via the data flow.

15. The computing system of claim 14, wherein the data integration plug-in comprises a fourth function that, when executed, is configured to cause the data integration plug-in to:
receive a plurality of additional user inputs;
transform the additional user inputs into an instruction in the data query language; and
execute the instruction to write the output dataset to a location in the data aggregation platform based on the additional user inputs.

16. The computing system of claim 15, wherein the data flow comprises a call to execute at least one of the first function, the second function, the third function, and the fourth function.

17. The computing system of claim 8, wherein the data flow UI comprises a workspace and graphical elements configured to be drag-and-dropped in the workspace, wherein an arrangement of the graphical elements represents the data flow.

18. The computing system of claim 8, wherein the user inputs comprise a selection of one or more time ranges, the query is configured to request time series data points corresponding to the one or more time ranges, and the input dataset comprises the requested time series data points.

19. A method, comprising:
providing, via a data analysis platform, a data flow user interface (UI) for configuring a data flow in a computing system;
ingesting, by the data analysis platform, input data from a data aggregation platform via a data integration plug-in of the data analysis platform;
integrating, via the data analysis platform, the input data into the data flow;
generating, via the data analysis platform, output data based on the input data via the data flow; and
writing, via the data analysis platform, the output data to the data aggregation platform using an instruction generated by the data integration plug-in.

20. The method of claim 19, wherein generating the output data comprises executing a machine learning model to predict the output data based on the input data.
